(19) United States
(12) Patent Application Publication
(10) Pub. No.: US 2008/0276879 A1
(43) Pub. Date: Nov. 13, 2008

(54) SYSTEM AND METHOD FOR FENCELESS ANIMAL CONTROL

(76) Inventor: Robert E. Marsh, Kansas City, MO (US)

Correspondence Address: HOVEY WILLIAMS LLP, 10801 Mastin Blvd., Suite 1000, Overland Park, KS, 66210, US

(21) Appl. No.: 12/116,854

(22) Filed: May 7, 2008

Related U.S. Application Data
(60) Provisional application No. 60/928,874, filed on May 11, 2007.

(51) Int. Cl. A01K 15/04

(52) U.S. Cl. 119/719; 119/721

(57) ABSTRACT

A system and method for fencelessly controlling the location of an animal comprising a location determining component and a stimulus device adapted to attach to the animal. The location determining component may send the location of the animal to a computing device, which may determine the location relative to the boundary and a warning zone of the boundary. If the location is within the warning zone of the boundary, the computing device may determine if the animal has moved closer to the boundary or farther from the boundary based on its computed current distance from the boundary and its last recorded distance from the boundary. If the animal has moved closer to the boundary, a first stimulus or negative feedback may be provided to the animal. If the animal has moved away from the boundary, a second stimulus or positive feedback may be provided to the animal.

### RELATED APPLICATIONS

This nonprovisional patent application claims priority benefit, with regard to all common subject matter, of earlier-filed U.S. provisional patent application titled “Multiple Feedback Animal Control Device,” Ser. No. 60/928,874, filed May 11, 2007. The identified earlier-filed application is hereby incorporated by reference in its entirety into the present application.

### BACKGROUND

1. Field

Embodiments of the present invention relate to a system and method of fenceless control of animals, and more particularly, to the control of livestock and other domesticated animals utilizing receivers attached to the animals for receiving data identifying the location of the animal and administering appropriate control stimuli to the animal based on the location of the animal relative to a desired location.

2. Related Art

Animal owners often desire to remotely and/or automatically control the behavior of an animal to, for example, train or contain the animal. For example, farmers often wish to contain livestock in a particular area and prevent the livestock from approaching and entering other areas. One method of remotely controlling the behavior of an animal is by delivering a stimulus to the animal when the animal's behavior deviates from a desired pattern of behavior. An exemplary device for delivering a stimulus is an animal collar adapted to deliver an electrical shock or an acoustical stimulus to the animal.

Containment systems using such devices may perform autonomous location determination using, for example, a Global Positioning System (GPS). In such systems, animal control devices may include a Global Positioning System (GPS) receiver and memory element thereon, wherein the memory element is adapted to store map or location information relating to a boundary or a restricted area. Such devices are adapted to determine a location by using information from the GPS receiver and the map or location information. If the animal wearing the collar approaches or enters a restricted area, the collar delivers a corrective stimulus, such as an electrical shock or an acoustical stimulus, thus motivating the animal to leave the restricted area.

However, current animal containment or barrier systems having GPS capabilities as discussed above may confuse the animal in various situations. Because there is no visible boundary, for example, there may be situations in which the animal receives a corrective stimulus but does not immediately know which direction to move, or worse, moves a short distance in a desired or appropriate direction but receives another corrective stimulus. These issues are particularly acute where the boundary location has changed since the animal's last encounter with it.

Accordingly, there is a need for a system and method for fenceless animal control that does not suffer from the problems and limitations of the prior art.

### SUMMARY

Various embodiments of the present invention provide an invisible barrier system to control the location of animals without requiring physical fencing. The invisible barrier system may comprise a location determining component, such as a global positioning system (GPS) receiver, and a stimulus device for providing at least one stimulus to the animal. The location determining component and the stimulus device may both be attached to the animal. The confinement system may further comprise a computing device, memory, a user interface, a display, a transmitter, a receiver, a power source, and I/O ports. The stimulus provided by the stimulus device to the animal may be an audible warning, an electric shock, a vibration, a visual warning, or any other type of stimulus known in the art. Various components of the confinement system 10 may be attached to the animal via a collar, an ear tag, a harness, or any means known in the art for securing an object to an animal.

The computing device may compare the location information with defined boundary parameters and activate the stimulus when the animal wearing the location determining component crosses the defined boundary. Additionally, if the animal is determined to be within a given warning zone from the boundary, a stimulus may be provided to the animal as a warning that the animal is too close to the boundary.

In various embodiments of the invention, a first stimulus may be provided when the animal is within the warning zone and moving towards the boundary, and a second stimulus may be provided as the animal begins to move away from the boundary but is still within the warning zone. To determine if the animal is moving towards or away from the boundary, the computing device may obtain the positions of the animal at a given time interval and store at least one previous position reading in memory such that the distance of a current position to the boundary may be compared with the distance of the previously-stored position to the boundary.

The first stimulus may, for example, be a tone having a first pitch, while the second stimulus may be the tone having a second pitch. Alternatively, the first stimulus may be an audible tone that gradually rises in pitch and/or volume as the animal approaches the boundary within the warning zone and the second stimulus may be an audible tone that gradually decreases in pitch and/or volume as the animal moves away from the boundary within the warning zone. In some embodiments of the invention, a third stimulus, such as an electric shock, may be provided when the animal crosses the boundary.

These and other important aspects of the present invention are described more fully in the detailed description below.

### BRIEF DESCRIPTION OF THE DRAWINGS

Embodiments of the present invention are described in detail below with reference to the attached drawing figures, wherein:

FIG. 1 is a diagram of an invisible barrier system according to embodiments of the present invention;

FIG. 2 is a block diagram illustrating certain components of the invisible barrier system of FIG. 1;

FIG. 3 is a schematic diagram of a Global Positioning System (GPS) that may be used to send GPS signals to the invisible barrier system of FIG. 1;

FIG. 4 is a map of a geographic boundary and warning zone as defined in and monitored by the invisible barrier system; and

FIG. 5 is a flow chart illustrating method steps that may be performed by the invisible barrier system.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawing figures that illustrate specific embodiments in which the present invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense.

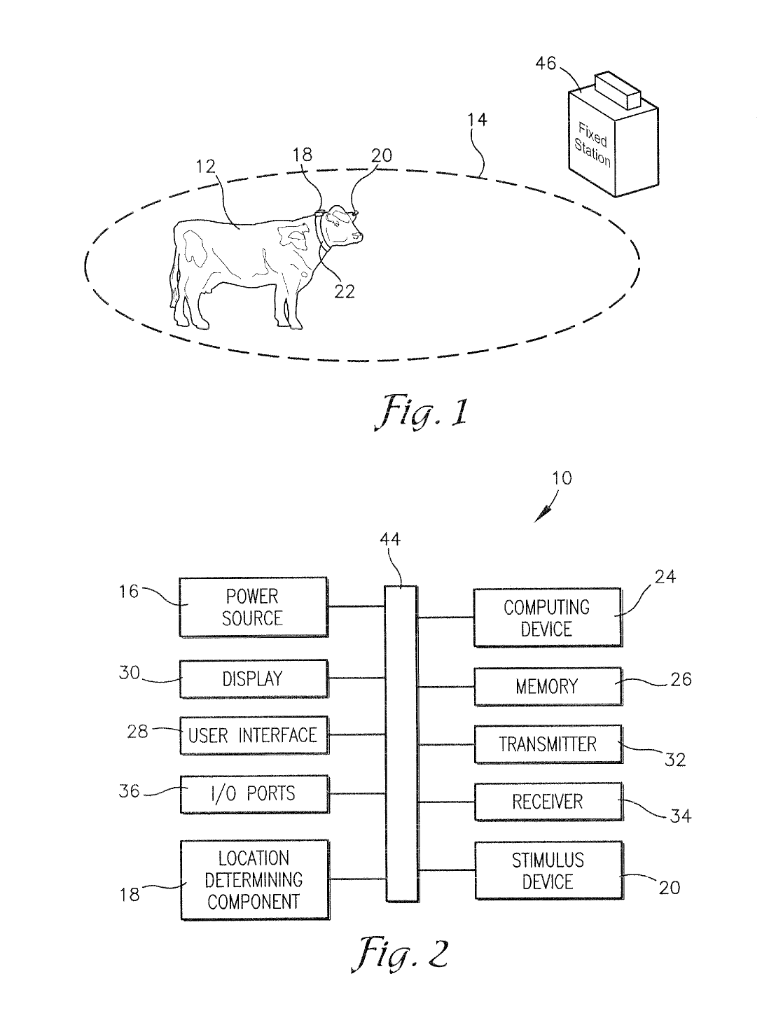

Embodiments of the present invention, as illustrated in FIGS. 1 and 2, provide an invisible barrier system 10 for preventing an animal 12 from crossing a desired geographic boundary 14 without the use of fences or other physical barriers. The invisible barrier system 10 may comprise a location determining component 18, a stimulus device 20 for providing at least one stimulus to the animal 12 depending on its location, and an attachment apparatus 22 for securing the location determining component 18 and the stimulus device 20 to the animal. The invisible barrier system 10 may further comprise a computing device 24, memory 26, a user interface 28, a display 30, a transmitter 32, a receiver 34, a power source 16, and I/O ports 36.

Exemplary automated animal control systems are disclosed in U.S. Pat. Nos. 5,868,100; 6,155,208; and 6,956,483, all of which are hereby incorporated by reference in their entirety into the present application.

The animal 12 may be a cow, horse, sheep, swine or other livestock, or may be pet, such as a dog or cat. It will be appreciated that the animal 12 is not limited to those listed and discussed herein, but may be virtually any animal.

The location determining component 18 determines positions of the animal 12 as it moves from place to place and generates and sends corresponding position data to the computing device 24. The location determining component 18 may use global positioning system (GPS) data, as taught in U.S. Pat. No. 5,868,100. U.S. Pat. No. 5,868,100 is hereby incorporated by reference in its entirety, and, in particular, the GPS system and components disclosed therein. Alternatively, the location determining component 18 may use RF system data.

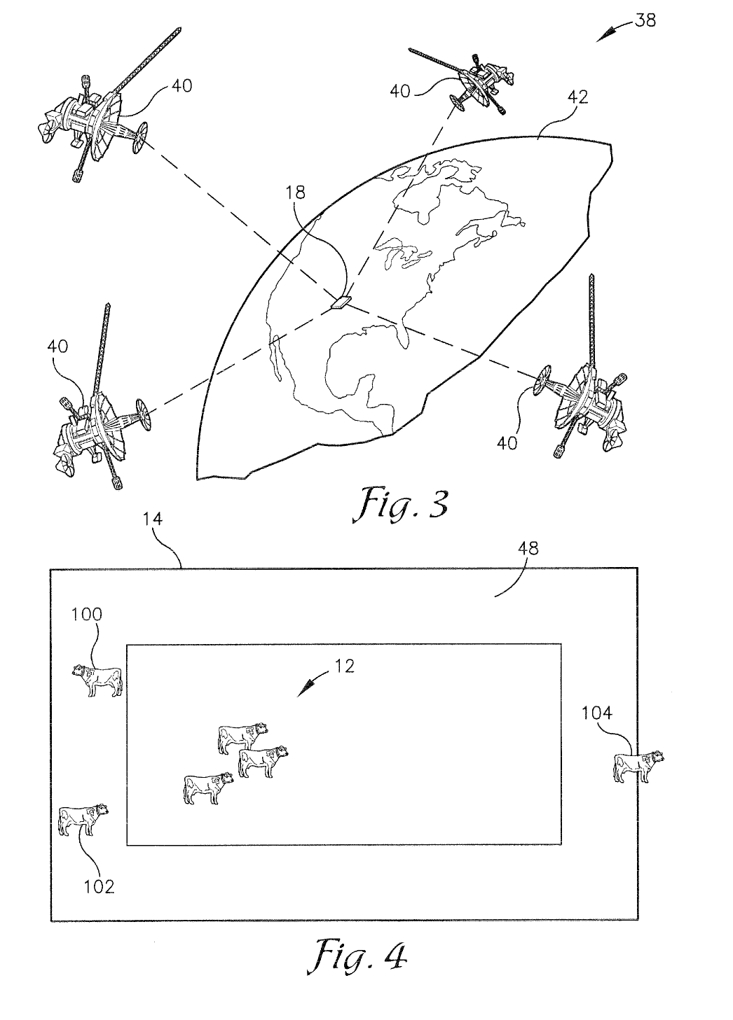

FIG. 3 shows a representative view of a global positioning system denoted generally by reference numeral 38. A plurality of satellites 40 are in orbit about the Earth 42. The orbit of each satellite is not necessarily synchronous with the orbits of other satellites and, in fact is likely asynchronous. The location determining component 18 is shown as a GPS receiver, receiving spread spectrum GPS satellite signals from the various satellites 40. The location determining component 18 may include an antenna to assist in receiving the satellite signals. The antenna may be a removable quad-helix antenna or any other type of antenna that can be used with navigational devices.

The spread spectrum signals continuously transmitted from each satellite 40 utilize a highly accurate frequency standard accomplished with an extremely accurate atomic clock. Each satellite 40, as part of its data signal transmission, transmits a data stream indicative of that particular satellite. As a GPS receiver, the location determining component 18 must acquire spread spectrum GPS satellite signals from at least three satellites for the location determining component 18 to calculate its two-dimensional position by triangulation. Acquisition of an additional signal, resulting in signals from a total of four satellites, permits the location determining component 18 to calculate its three-dimensional position.

Although in one embodiment the location-determining device 18 is a GPS receiver, it is noted that equivalents may be employed and substitutions made without departing from the scope of the invention as recited in the claims. For example, in various embodiments of the invention, the location determining component 18 need not directly determine its current geographic position. For instance, the location determining components 8 may determine the current geographic position by receiving position information directly from the user, through a communications network, or from another electronic device.

The location determining component 18 may include one or more processors, controllers, and/or other computing devices and memory so that it may calculate position and other geographic information without the computing device 24. Further, the location determining component 18 may be integral with the computing device 24 such that the location determining component 18 may be operable to specifically perform the various functions described herein. Thus, the computing device 24 and location determining component 18 can be combined or be separate or otherwise discrete elements.

The stimulus device 20 may be electrically and/or communicably coupled with the location determining components 8 and the computing device 24. The stimulus device 20 may be physically integrated with the location determining component 18 and the computing device 24, or alternatively may be attached to the animal 12 independently and may communicate with the location determining component 18 and computing device 24 via wireless transmitters and receivers, such as RF transmitters and other devices for wireless transmission as known in the art as described herein. The stimulus device 20 may be any device that provides a stimulus, such as an audible warning, an electric signal, a vibration, a visual warning, or any other type of stimulus known in the art. Additionally, the stimulus device 20 may provide various types of stimuli individually or in combination with other types of stimuli. For example, the stimulus device may provide both an audible warning and an electric shock simultaneously or in series. The audible warning may include any combination of frequencies, pitches, and volume levels and may sound for any duration of time. For example, the audible warning may be a series of short, loud, high-pitched tones or a continuous, loud, high-pitched tone which only stops when the location determining component 18 is no longer near or no longer past the boundary 14.

The attachment apparatus 22 may be a collar, an ear tag, a harness, or any means known in the art for securing an object to an animal. In various embodiments of the invention, the location determining component 18 and the stimulus device 20 may be attached to the animal using two separate attachment apparatuses 22. For example, the stimulus device 20 may be attached to the animal's ear using an ear tag, while the location determining component 18 may be attached to the animals neck using a collar. Alternatively, all components of the system 10 may be attached to the animal using the single attachment apparatus 22.

In various embodiments of the invention, the attachment apparatus 22 may incorporate means for monitoring desired physiological parameters of the animal, such as body temperature, blood pressure, or heart parameters. Systems for monitoring these parameters are well known, such as the system described in U.S. Pat. No. 4,399,821, incorporated herein by reference and made a part of the disclosure hereof. Signals representing this physiological information may be included with the location information signals transmitted to the computing device 24.

The computing device 24 may include any number of processors, controllers, integrated circuits, programmable logic devices, or other computing devices and resident or external memory for storing data and other information accessed and/or generated by the invisible barrier system 10. The computing device 24 may be coupled with the location determining component 18, the stimulus device 20, the memory 26, the user interface 28, the display 30, the transmitter 32, the receiver 34, the power source 16, the I/O ports 36, and other components through wired or wireless connections, such as a data bus 44, to enable information to be exchanged between the various components.

The computing device 24 may implement a computer program and/or code segments to perform the functions described herein. The computer program preferably comprises an ordered listing of executable instructions for implementing logical functions in the computing device 24. The computer program can be embodied in any computer-readable medium for use by or in connection with an instruction execution system, apparatus, or device, and execute the instructions. As used herein, a “computer-readable medium” can be any means that can contain, store, communicate, propagate, or transport the program for use by or in connection with the instruction execution system, apparatus, or device. The computer-readable medium can be, for example, but not limited to, an electronic, magnetic, optical, electro-magnetic, infrared, or semi-conductor system, apparatus, device or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

In some embodiments of the invention, the computing device 24 and other components of the invisible barrier system 10 may be located remotely in relation to the animal 12, the location determining component 18, and/or the stimulus device 20. For example, the stimulus device 20 and the location determining component 18 may be located on the collar of the animal 12, while the computing device 24 and memory 26 may be located in a fixed station 46 which is not attached to the animal 12, as illustrated in FIG. 1. In various embodiments of the invention, the computing device 24 may be used to determine the location of and activate stimuli for a plurality of animals having location determining components 18 and stimulus devices 20 attached to their bodies. Additionally, a user at the fixed station 46 could be notified if any one of the animals crosses the boundary 14.

The memory 26 may be integral with the location determining component 18, integral with the computing device 24, stand-alone memory, or a combination of both. The memory may include, for example, removable and non-removable memory elements such as RAM, ROM, flash, magnetic, optical, USB memory devices, and/or other conventional memory elements. In various embodiments of the invention, the memory 26 may be remotely programmable to receive and store parameters for the desired boundary 14.

The memory 26 may store various data associated with the operation of the invisible barrier system 10, such as the computer program and code segments mentioned above, or other data for instructing the computing device 24 and system elements to perform the steps described herein. Further, the memory 26 may store: physiological information about the animal 12; data corresponding to geographic positions of the animal 12 or animals; parameters for the boundary 14 including map data and map elements; a sample rate or a determination interval defining the amount of time between each obtaining of the animal's position; and other information to facilitate the various functions provided by the invisible barrier system 10. The various data stored within the memory 26 may also be associated with one more databases to facilitate retrieval of the information. Additionally, the memory 26 may store previously calculated or otherwise acquire animal position information for later retrieval by the computing device 24. For example, the stored position information for a previous location of the animal 12 may be retrieved and compared with a present location of the animal 12 in order to determine if the animal is moving toward or away from the boundary 14.

The user interface 28 permits a user to operate the invisible barrier system 10 and enables users, third parties, or other devices to share information with the confinement system 10. The user interface 28 may comprise one or more functionable inputs such as buttons, switches, scroll wheels, a touch screen associated with the display 30, voice recognition elements such as a microphone, pointing devices such as mice, touchpads, tracking balls, styluses, a camera such as a digital or film still or video camera, combinations thereof, etc. Further, the user interface 28 may comprise wired or wireless data transfer elements such as a removable memory including the memory 26, data transceivers, etc., to enable the user and other devices or parties to remotely interface with the confinement system 10. The device may also include a speaker for providing audible instructions and feedback.

The user interface 28 may provide various information to the user utilizing the display 30 or other visual or audio elements such as a speaker. Thus, the user interface 28 enables the user and confinement system 10 to exchange information relating to the confinement system 10, including configuration information, preferences, alerts, stimulus limits (limiting intensity, frequency of occurrence, etc.), boundary parameters, desired physiological parameters of the animal 12, a sample rate of location information, type of stimulus to apply, etc.

The display 30 is coupled with the computing device 24 and is operable to display various information corresponding to the animal 12 and the invisible barrier system 10, such as maps, positions, the boundary 14, and physiological information regarding the animal 12. The display 30 may comprise conventional black and white, monochrome, or color display elements including CRT, TFT, LCD, and/or plasma display devices. The display 30 may be integrated with the user interface 28, such as in embodiments where the display 30 is a touch-screen display to enable the user to interact with it by touching or pointing at display areas to provide information to the invisible barrier system 10.

The transmitter 32 and receiver 34 may communicate with each other wirelessly, exchanging data between the location determining component 18, the stimulus device 20, and the computing device 24. In various embodiments of the invention, a plurality of the confinement system 10 components are each coupled with individual transmitters and receivers, so that each of these components may send and receive data signals.

The transmitter 32 may include antennas, amplifiers, tuners, filters, encoders, and other components for transmitting data signals wirelessly, as known in the art. The transmitter 32 may transmit at a wide range of carrier frequencies and may encode or modulate data using FM, QAM, PSK, etc. The transmitter 32 may include analog electronics, digital electronics, or a combination of both, as well as electrical components such as microprocessors, microcontrollers, or digital signal processors.

The receiver 34 may include antennas, amplifiers tuners filters, decoders, and other components for receiving wireless data signals, as known in the art. The receiver may receive a wide range of carrier frequencies and may decode or demodulate data using FM, QAM, PSK, etc. The receiver 34 may include analog electronics, digital electronics, or a combination of both, as well as electrical components such as microprocessors, microcontrollers, or digital signal processors.

The I/O ports 36 permit data and other information to be transferred to and from the computing device 24 and the location determining component 18. The I/O ports 36 may include a TransFlash card slot for receiving removable TransFlash cards and a USB port for coupling with a USB cable connected to another computing device such as a personal computer. Maps, boundaries, stimulus limits, physiological data, and other data and information may be loaded in the confinement system 10 via the I/O ports 36.

The power source 16 provides electrical power to various invisible barrier system 10 elements. For example, the power source 16 may be directly or indirectly coupled with the location determining component 18, the stimulus device 20, and the computing device 24. The power source 16 may comprise conventional power supply elements such as batteries, battery packs, etc. The power source 16 may also comprise power conduits, connectors, and receptacles operable to receive batteries, battery connectors, or power cables.

As discussed, the boundary 14 may be defined by data stored in the memory 26, user input of boundary parameters into the computing device 24, and various other methods. The user may also change the location of the boundary 14 as needed via the user interface 28, wireless transmission, or the I/O ports 36. The boundary 14 may form a complete 360-degree enclosure around the animal(s) 12. Alternatively, the boundary may not surround the animals, but rather forms an invisible barrier between the animals and a danger, such as a power box or a cliff. Known geographic coordinates of various boundary points may be interpolated to form the boundary 14.

For example, the user may define a rectangle by entering the latitude and longitude of each of the four corners or a circle by the latitude and longitude of its center and a specified radius. Other standard shapes could be preprogrammed into the memory 26, or irregular shapes may be defined by the interpolation of a plurality of geographical positions. The design and operation of means for entering boundary parameters are well known in the art and are not repeated here.

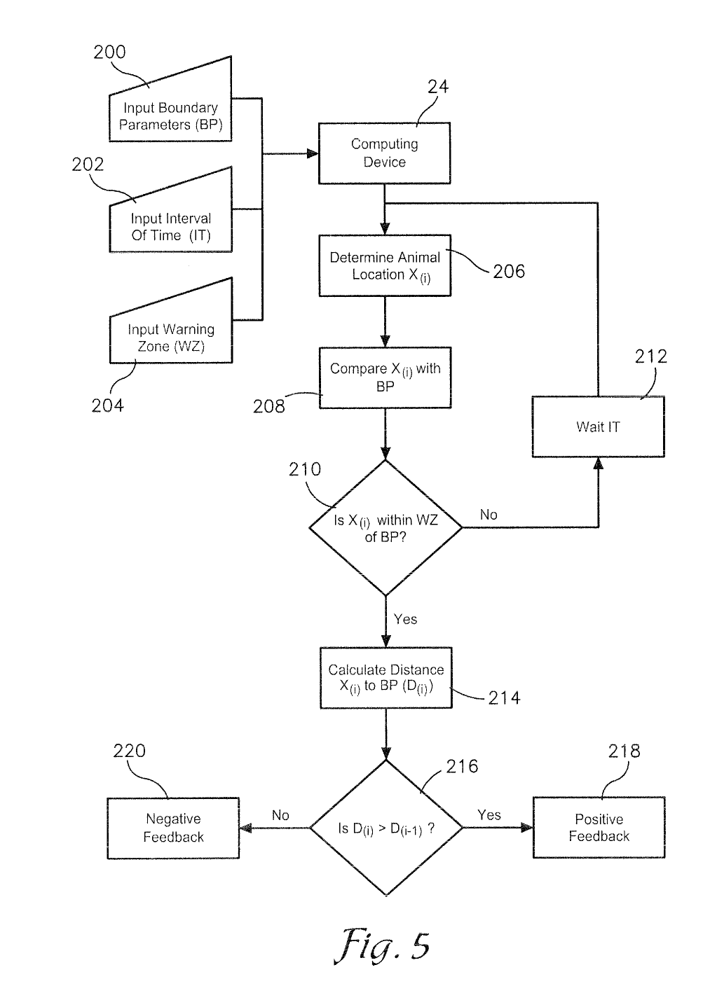

The warning zone 48, illustrated in FIG. 4, may be defined by the user via the user interface 28 or may otherwise be provided to the computing device 24 via the memory 26, I/O ports 36, or wireless transmission. The warning zone 48 is on the same side of the boundary 14 as the animal(s) are desired to remain and begins at a pre-defined distance from the boundary 14, extending all the way to the boundary 14. For example, the warning zone 48 may be inward of the boundary 14 in the case of a 360-degree boundary surrounding the animals. However, in a situation where the boundary 14 surrounds an area that the animals should not enter, such as an open well, the warning zone may be outward of the 360-degree boundary 14. In various embodiments of the invention, the warning zone 48 may begin at a distance within the range of 1 m to 500 m away from the boundary 14. Alternatively, the warning zone 48 may begin at a distance within the range of 10 m to 100 m away from the boundary or within the range of 20 m to 50 m away from the boundary.

In use, the computing device 24 may compare the location of the animal 12 with the boundary 14 and activate the stimulus device 20 when the animal 12 crosses the defined boundary 14. Additionally, if the animal 12 is determined to be within the warning zone 48, a stimulus may be provided to the animal as a warning that the animal is too close to the boundary 14. For example, if the computing device 24 determines that the animal 12 has moved within the warning zone 48 or within a defined distance, say five meters, of the boundary 14, the stimulus device 20 may be activated.

The computing device 24 may define appropriate stimuli to the animal 12 for various circumstances, such as when the animal 12 is within the warning zone 48, approaches the boundary 14, crosses the boundary 14, or moves away from the boundary 14. The computing device 24 may contain stimuli information and instructions in memory 26 or may receive instructions regarding appropriate types and amounts of stimuli from the user via the user interface 28, I/O ports 36, or wireless transmission.

In various embodiments of the invention, a first stimulus may be provided when the animal wearing the location determining component 18 is within the warning zone 48 and moving towards the boundary 14, as illustrated by animal 100 in FIG. 4, and a second stimulus may be provided as the animal begins to move away from the boundary 14, but is still within the warning zone 48, as illustrated by animal 102 in FIG. 4.

To determine if the animal 12 is moving towards or away from the boundary 14, the computing device 24 may obtain a current position of the animal at a current point in time from the location determining component 18 and obtain at least one previously determined position at a previous point in time from memory 26 such that the distance of the current position to the boundary 14 may be compared with the distance of the previously-determined position to the boundary 14. If the distance to the boundary 14 has decreased or remained the same, then the first stimulus may be provided. If the distance to the boundary 14 has increased, then the second stimulus may be provided.

In one embodiment of the invention, as illustrated in the flow chart of FIG. 5, the computing device 24 may receive input boundary parameters 200, an input interval of time 202, and an input warning zone 204. Next, based on input from the location determining component 18, the computing device 24 may determine the animal location X(i), as shown in step 206. Then, as shown in step 208, the computing device 24 may compare the animal location X(i) with the boundary parameters 200. Step 210 illustrates determining if X(i) is within the warning zone 204 of the boundary parameters 200. If it is not, then step 212 requires that the invisible barrier system 10 wait for the interval of time 202 to pass before obtaining the next location of the animal 12. If X(i) is within the warning zone 204 of the boundary parameters 200, then, as shown in step 214, the computing device 24 may calculate distance D(i), which is the distance between the current animal location X(i) and the boundary parameters BP.

In step 216, the computing device 24 may determine if D(i) is greater than D(i−1), or in other words if the animal's distance from the boundary 14 is greater than its previously-recorded distance from the boundary. If the distance D(i) is greater than D(i−1), then the second stimulus, also referenced as positive feedback 218, may be applied to the animal 12. If the distance D(i) is not greater than D(i−1), then the first stimulus, also referenced as negative feedback 220, may be applied to the animal 12.

The first stimulus may, for example, be a tone having a first pitch, while the second stimulus may be the tone having a second pitch. Alternatively, the first stimulus may be an audible tone that gradually rises in pitch, speed, and/or volume as the animal 12 approaches the boundary 14 within the warning zone 48 and the second stimulus may be an audible tone that gradually decreases in pitch, speed, and/or volume as the animal 12 moves away from the boundary 14 within the warning zone 48. In some embodiments of the invention, a third stimulus, such as an electric shock, may be provided when the boundary 48 is crossed by the animal, as illustrated by animal 104 in FIG. 4. In other words, if the current location of the animal 12 is on an undesired side of the boundary and the previously determined location of the animal 12 was on a desired side of the boundary 14, then a shock may be applied. Or, if the current location of the animal 12 corresponds with the boundary 14, then a shock may be applied.

In one embodiment of the invention, a continuous stimulus is activated when the animal 12 enters the warning zone 48, and the volume, speed, or pitch of the stimulus is gradually adjusted depending on the animal's proximity to the boundary 14. Thus, if the animal 12 has moved closer to the boundary 14 between the previous point in time and the current point in time, the volume of the stimulus may be adjusted upward by the computing device 24. Likewise, if the animal 12 has moved farther from the boundary 14 between the previous point in time and the current point in time, the volume of the stimulus may be adjusted downward by the computing device 24.

By using a different stimulus or differing the direction of adjustment of the stimulus when the animal 12 is approaching the boundary 14 than when the animal 12 is moving away from the boundary 14, the animal 12 may begin to associate these stimuli as negative feedback and positive feedback, and will respond accordingly. This is advantageous, since having only one type of feedback or stimulus provided to the animal while it is still within the warning zone 48 could confuse the animal 12 if it has already turned around and started moving away from the boundary 14 but continues to experience a warning stimulus. Therefore the present invention not only provides a negative or warning stimulus to the animal 12 as it moves closer to the boundary 14, but also provides positive stimulus or feedback as soon as the computing device 24 determines that the animal 12 is beginning to move away from the boundary 14. Once the animal moves a sufficient distance from the boundary 14, the positive stimulus would cease.

Although the invention has been described with reference to the embodiments illustrated in the attached drawings, it is noted that equivalents may be employed and substitutions made herein without departing from the scope of the invention as recited in the claims. For example, if the location determining component 18 is an RF system as discussed in U.S. Pat. No. 6,155,208, incorporated by reference above, differences in signal strength may be used to determine whether the animal 12 is moving toward or away from signal transmitters defining the boundary.

Having thus described an embodiment of the invention, what is claimed as new and desired to be protected by Letters Patent includes the following:

1. An animal control apparatus comprising:
a location determining component adapted to be worn by an animal and to output a first location signal indicating a first location of said animal at a first point in time and a second location signal indicating a second location of said animal at a second point in time, wherein said second point in time is later than said first point in time;
a computing device communicably coupled with said location determining component and adapted to compare said first location with a warning zone location and generate a first response signal in response to said first location signal if said first location is within said warning zone, and to compare said second location with said warning zone location and generate said first response signal in response to said second location signal if said second location is within said warning zone and is not further from a boundary than said first location, and generate a second response signal in response to said second location signal if said second location is within said warning zone and is further from said boundary than said first location; and
a stimulus device adapted to be worn by said animal and to deliver a first stimulus in response to said first response signal and a second stimulus in response to said second response signal, wherein said first stimulus differs from said second stimulus.

2. The animal control apparatus of claim 1, wherein the signals are only sent to the stimulus device if the first location is within a warning zone of the defined boundary.

3. The animal control apparatus of claim 1, wherein the computing device is adapted to send a third signal to the stimulus device when the first location corresponds to the boundary or is located on an undesired side of the boundary.

4. The animal control apparatus of claim 1, wherein at least one of the first and second stimuli is an audible tone.

5. The animal control apparatus of claim 1, wherein the first stimulus is a tone that is adjusted by the computing device to be at least one of louder, higher in pitch, and more frequent in occurrence than the second stimulus if the animal moves closer to the boundary.

6. The animal control apparatus of claim 1, wherein the second stimulus is a tone that is adjusted by the computing device to be at least one of louder, higher in pitch, and more frequent in occurrence than the first stimulus if the animal moves closer to the boundary.

7. The animal control apparatus of claim 3, wherein the third stimulus is an electric shock.

8. The animal control apparatus of claim 1, including an attachment apparatus for attaching at least one of the location determining component, the computing device, and the stimulus device to the animal.

9. The animal control apparatus of claim 1, further comprising a remote fixed station for housing the computing device, a transmitter, and a receiver for sending and receiving data signals wirelessly to and from the location determining component and the stimulus device.

10. The animal control apparatus of claim 1, further comprising a user interface adapted to send at least one of boundary parameters, sampling rate of location information, and type of stimulus to the computing device.

11. An animal control apparatus comprising:
a location determining component adapted to be worn by an animal and to output a first location of the animal and a second location of the animal;
a computing device communicably coupled with the location determining component and adapted to determine a first distance between the first location and a defined boundary and a second distance between the second location and the defined boundary, and adapted to output a first signal if the first distance is not greater than the second distance and the first location is within a warning zone of the defined boundary and to output a second signal if the first distance is greater than the second distance and the first location is within the warning zone of the defined boundary;
a stimulus device adapted to be worn by the animal and to deliver a continuous stimulus when the stimulus device receives the second or the first signal wherein the stimulus responds in one way when the stimulus device receives the first signal and the stimulus responds in another way when the stimulus device receives the second signal.

12. The animal control apparatus of claim 11, wherein the stimulus is an audible tone that increases in volume, pitch, or frequency of occurrence each time the stimulus device receives the first signal.

13. The animal control apparatus of claim 11, wherein the stimulus is an audible tone that decreases in volume, pitch, or frequency of occurrence each time the stimulus device receives the second signal.

14. The animal control apparatus of claim 11, wherein the computing device is adapted to send a third signal to the stimulus device when the first location is equal to the defined boundary or on an improper side of the defined boundary, and wherein the stimulus device provides a different stimulus in response to the third signal than the continuous stimulus provided in response to the first and second signal.

15. The animal control apparatus of claim 14, wherein the stimulus device provides an electric shock to the animal in response to the third signal.

16. The animal control apparatus of claim 11, including an attachment apparatus for attaching at least one of the location determining component, the computing device, and the stimulus device to the animal.

17. The animal control apparatus of claim 11 further comprising a remote fixed station housing the computing device, a transmitter, and a receiver for sending and receiving data signals wirelessly to and from the location determining component and the stimulus device.

18. The animal control apparatus of claim 11, further comprising a user interface for sending at least one of boundary parameters, a sampling rate of location information, and desired types of stimuli to the computing device.

19. A method for controlling an animal wearing a location determining component and a stimulus device, the method comprising:
sending a present location of the animal from the location determining component to a computing device;
comparing the present location to a defined geographic boundary and a warning zone extending between the boundary and a predetermined distance from of the boundary;
determining a first distance between the present location and a defined boundary and a second distance between a previous location and the defined boundary;
sending a first signal to the stimulus device if the present location is within the warning zone and the first distance is not greater than the second distance;
sending a second signal to the stimulus device if the present location is within the warning zone and the first distance is greater than the second distance;
applying a first stimulus to the animal if the first signal is received by the stimulus device; and
applying a second stimulus to the animal if the second signal is received by the stimulus device.

20. The method of claim 19, further comprising applying a third stimulus to the animal if the computing device determines that the animal has crossed the boundary.
